(19) United States
(12) Patent Application Publication
(10) Pub. No.: US 2019/0319913 A1
(43) Pub. Date: Oct. 17, 2019

(54) IMPLEMENTING A SUPPORT SESSION FOR AND FROM A STORAGE SYSTEM INDIRECTLY CONNECTED TO A WIDE AREA NETWORK

(71) Applicant: INTERNATIONAL BUSINESS MACHINES CORPORATION, Armonk, NY (US)

(72) Inventors: Rotem Klein, Kiryat Ono (IL); Daniel Lereya, Tel Aviv (IL); Nadav Parag, Rehovot (IL); Vladimir Shalikashvili, Petah Tiqwa (IL); Moshe Weiss, Petah Tiqwa (IL)

(21) Appl. No.: 15/954,926

(22) Filed: Apr. 17, 2018

(51) Int. Cl. H04L 12/58; H04L 29/08

(52) U.S. Cl. CPC H04L 51/38; H04L 67/146

(57) ABSTRACT

A storage system receives a support request notification that includes at least an identifier of a mobile device that is proximate to a management device of the storage system. The storage system generates a SMTP notification from the support request notification and sends the SMTP notification to a SMTP server. The SMTP server sends the SMTP notification to a support server. The support server broadcasts the support request to one or more support devices. An accepting support device accepts the support request. The support server implements a message gateway between the accepting support device and the proximate mobile device. The accepting support device sends a support response to the proximate mobile device. The proximate device may provide the support response and/or may send the support response to the management device which may provide the support response.

### FIELD OF THE INVENTION

Embodiments of the invention generally relate to computer systems and more particularly to implementing a support session for and from a storage system that is indirectly connected to a wide area network.

### DESCRIPTION OF THE RELATED ART

Some storage systems are managed by a management device, such as a computer. The management device may include user interfaces that allow for a user to control functionality and/or operations of the storage device. Typically, to implement a support session, such as an on-line chat session, the management device and/or the storage system must be connected to a remote support agent's device by a wide area network (WAN) that extends over a large geographical distance. As such, when the management device and/or the storage system is not itself directly connected to the WAN, a support session is typically not available.

### SUMMARY

In an embodiment of the present invention, a method for implementing a support session for and from a storage system is presented. The method includes receiving, with the storage system, a support session request notification, the support session request notification comprising a mobile device identifier that uniquely identifies an associated proximate mobile device that is communicatively connected to a storage system management device by a personal area network (PAN). The method further includes generating, with the storage system, an Simple Mail Transfer Protocol (SMTP) notification comprising the mobile device identifier and receiving, with a support session management server, the SMTP notification. The method further includes receiving, with the support session management server, a support session acceptance notification from an accepting support device and establishing, with the support session management server, a communication gateway between the accepting support device and the proximate mobile device associated with the mobile device identifier. The method further includes routing, with the support session management server, a support message from the accepting support device to the proximate mobile device associated with the mobile device identifier.

In another embodiment of the present invention, a computer program product for implementing a support session for and from a storage system is presented. The computer program product includes computer readable storage mediums having program instructions embodied therewith. The program instructions are readable to cause a processor of the storage system to receive a support session request notification, the support session request notification comprising a mobile device identifier that uniquely identifies an associated proximate mobile device that is communicatively connected to a storage system management device by a personal area network (PAN). The program instructions are readable to cause the processor of the storage system to generate an Simple Mail Transfer Protocol (SMTP) notification comprising the mobile device identifier. The program instructions are readable to cause a processor of a support session management server to receive the SMTP notification. The program instructions are readable to cause the processor of the support session management server to receive a support session acceptance notification from an accepting support device. The program instructions are readable to cause the processor of the support session management server to establish a communication gateway between the accepting support device and the proximate mobile device associated with the mobile device identifier. The program instructions are readable to cause the processor of the support session management server to route a support message from the accepting support device to the proximate mobile device associated with the mobile device identifier.

In another embodiment of the present invention, a system for implementing a support session for and from a storage system is presented. The system includes a plurality of memories having program instructions embodied therewith. The program instructions are readable to cause a processor of the storage system to receive a support session request notification, the support session request notification comprising a mobile device identifier that uniquely identifies an associated proximate mobile device that is communicatively connected to a storage system management device by a personal area network (PAN). The program instructions are readable to cause the processor of the storage system to generate an Simple Mail Transfer Protocol (SMTP) notification comprising the mobile device identifier. The program instructions are readable to cause a processor of a support session management server to receive the SMTP notification. The program instructions are readable to cause the processor of the support session management server to receive a support session acceptance notification from an accepting support device. The program instructions are readable to cause the processor of the support session management server to establish a communication gateway between the accepting support device and the proximate mobile device associated with the mobile device identifier. The program instructions are readable to cause the processor of the support session management server to route a support message from the accepting support device to the proximate mobile device associated with the mobile device identifier.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary storage system, according to various embodiments of the invention.

FIG. 2 illustrates a high-level block diagram of an exemplary support server, according to various embodiments of the invention.

FIG. 3 illustrates a high-level block diagram of a storage system management device, according to various embodiments of the invention.

FIG. 4 illustrates a high-level block diagram of a proximate mobile device, according to various embodiments of the invention.

FIG. 5 illustrates a high-level block diagram of a Simple Mail Transfer Protocol (SMTP) server, according to various embodiments of the invention.

FIG. 6 illustrates a high-level block diagram of a support device, according to various embodiments of the invention.

FIG. 7 illustrates a high-level block diagram of a mobile support device, according to various embodiments of the invention.

FIG. 8 illustrates an exemplary method implementing a support chat session for and from a storage system that is indirectly connected to a wide area network, according to various embodiments of the invention.

### DETAILED DESCRIPTION

A storage system receives a support request notification that includes at least an identifier of a mobile device that is proximate to a management device of the storage system. The storage system generates a SMTP notification from the support request notification and sends the SMTP notification to a SMTP server. The SMTP server sends the SMTP notification to a support server. The support server broadcasts the support request to one or more support devices. An accepting support device accepts the support request. The support server implements a message gateway between the accepting support device and the proximate mobile device. The accepting support device sends a support response to the proximate mobile device. The proximate device may provide the support response and/or may send the support response to the management device which may provide the support response.

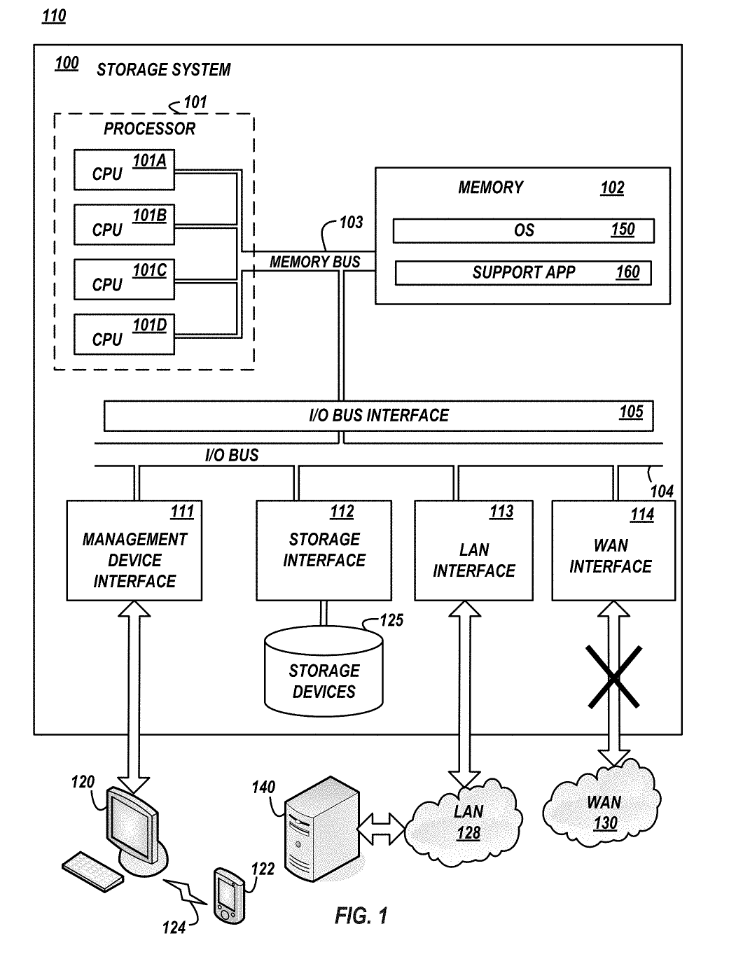

Referring to the Drawings, wherein like numbers denote like parts throughout the several views, FIG. 1 depicts a high-level block diagram representation of an exemplary storage system 100. Storage system 100 may include one or more processors 101, a main memory 102, a management device interface 111, a storage interface 112, a local area network (LAN) interface 113, and/or a wide area network (WAN) interface 114, all of which are communicatively coupled, directly or indirectly, for inter-component communication via a memory bus 103, an I/O bus 104, and/or an I/O bus interface 105. The storage system 100 contains one or more general-purpose programmable central processing units (CPUs) 101A, 101B, 101C, and 101D, herein generically referred to as the processor 101. In an embodiment, the storage system 100 contains multiple processors typical of a relatively large system; however, in another embodiment the storage system 100 may alternatively be a single CPU system. Each processor 101 executes instructions stored in the main memory 102 and may comprise one or more levels of on-board cache.

In an embodiment, the main memory 102 may comprise a random-access semiconductor memory or storage medium for storing or encoding data and programs. In another embodiment, the main memory 102 represents the entire virtual memory of the storage system 100 and may also include the virtual memory of other computer systems coupled to the storage system 100. The main memory 102 is conceptually a single monolithic entity, but in other embodiments the main memory 102 is a more complex arrangement, such as a hierarchy of caches and other memory devices. For example, memory 102 may exist in multiple levels of caches, and these caches may be further divided by function, so that one cache holds instructions while another holds non-instruction data, which is used by the processor or processors. Memory 102 may be further distributed and associated with different CPUs or sets of CPUs, as is known in any of various so-called non-uniform memory access (NUMA) computer architectures.

The main memory 102 stores or encodes an operating system 150 and a portion of a support application 160, or the like. While operating system 150 and support application portion 160 are illustrated as being contained within the main memory 102, these elements are not necessarily all completely contained in the same memory at the same time. Further, although operating system 150 and support application portion 160 are illustrated as being separate entities, in other embodiments some of them, portions of some of them, or all of them may be packaged together. Operating system 150 support application portion 160 generally comprise program instructions or statements that are called and executed by the processor 101 to cause the storage system 100 to implement functionality further described herein.

The memory bus 103 provides a data communication path for transferring data among the processor 101, the main memory 102, and the I/O bus interface 105. The I/O bus interface 105 is further coupled to the system I/O bus 104 for transferring data to and from the various I/O interfaces. The I/O bus interface 105 communicates with multiple I/O interfaces 111, 112, 113, and 114 through the system I/O bus 104. The I/O interfaces support communication with a variety of devices. For example, the management device interface 111 supports the attachment of a management device 120 which may comprise user output devices (such as a video display device, speaker, and/or television set) and user input devices (such as a keyboard, mouse, microphone, keypad, touchpad, trackball, buttons, light pen, or other pointing device). A user may manipulate the user input devices using a user interface to provide input data and commands to management device 120 and may receive output data via the user output devices. For example, a user interface may be presented by management device 120, such as displayed on a display device, played via a speaker, or printed via a printer. Management device 120 may be communicatively connected to storage system 100 by a bus connection, such as a universal serial bus (USB).

The storage interface 112 supports the attachment of one or more storage devices 125. In an embodiment, the storage devices 125 are rotating magnetic disk drive storage devices, solid state storage devices, or similar other types of storage device(s). The contents of the main memory 102, or any portion thereof, may be stored to and retrieved from the storage device(s) 125, as needed. The local storage devices 125 generally have a slower access time than does the memory 102, meaning that the time needed to read and/or write data from/to the memory 102 is less than the time needed to read and/or write data from/to for the local storage device(s) 125.

The LAN interface 113 provides one or more communications paths from the storage system 100 to other local devices, such as SMTP server 140, by way of LAN 128. Generally, a “LAN” is defined herein to be one computer network that communicatively interconnects devices within that LAN and that may be located within a similar proximate area, such as the same residence, same school, same laboratory, same office building, same data center, or the like.

The WAN interface 114 provides one or more communications paths from the storage system 100 to other remote devices by way of WAN 130. Generally, a WAN is defined herein to be one or more computer networks that communicatively interconnect remote devices that are located within different LANs and that may be separated by a long distance (e.g., the remoted devices are in different regions, states, countries, or the like). WAN 130 may be any suitable WAN communication network or combination of WAN networks and may support any appropriate WAN protocol suitable for communication of data. In various embodiments, the WAN communication network may represent a WAN data handling device or a combination of data handling devices, such as switches, routers, or the like, either connected directly or indirectly. In another embodiment, the WAN communication network may support wireless communications. In another embodiment, the WAN communication network, or portion thereof, may support hard-wired communications, such as a telephone line or cable. In another embodiment, the WAN communication network, or portion thereof, may be the Internet. In another embodiment, the WAN communication network, or portion thereof, is implemented as a hotspot service provider network. In another embodiment, the WAN communication network, or portion thereof, is implemented as an intranet. In another embodiment, the WAN communication network, or portion thereof, is implemented as any appropriate cellular data network, cell-based radio network technology, or wireless network

The proximity distinction between the local devices within LAN 128 and remote devices that are communicatively connected by WAN 130 stems from LAN networking devices, which operate at lower layers of the Open Systems Interconnection model, being designed solely for physically proximal networks and are generally unable to transmit data over tens, hundreds or even thousands of miles or kilometers.

A mobile device 122, which may be referred herein as a proximate mobile device, may be connected to management device 120 by personal area network (PAN) 124. The PAN 124 provides one or more communications paths to and from the management device 120 from and to the proximate mobile device 122. Generally, a PAN is defined herein to be one computer network that communicatively interconnect devices located within an individual person's workspace. PAN 124 consists of a wired connection, such as a USB connection, or a wireless connection, such as a radio frequency messaging connection, infrared data association (IrDA) connection, a wireless USB connection, a Bluetooth connection, a Z-Wave connection, or a ZigBee connection.

Although the memory bus 103 is shown as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective entities, the storage system 100 may, in fact, contain multiple I/O bus interfaces 105 and/or multiple I/O buses 104. While multiple I/O interfaces are shown, which separate the system I/O bus 104 from various communications paths running to the various I/O devices, in other embodiments some or all of the I/O devices are connected directly to one or more system I/O buses.

WAN interface 114 may contain electronic components and logic to adapt or convert data of one protocol on I/O bus 104 to another protocol on another bus. For example, WAN interface 114 may connect a wide variety of devices to storage system 100 and to each other such as, but not limited to, a host computer that stores host data to the storage system 100, using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, WAN connections, high performance graphics, etc.

Though shown as distinct entities, the multiple I/O interfaces 111, 112, 113, and 114 or the functionality of the I/O interfaces 111, 112, 113, and 114 may be integrated into the same entity.

In various embodiments, the storage system 100 is a multi-user storage system, a single-user storage system, or a similar device that has little or no direct user interface, receives data storage read and/or write requests from the host computer(s), receives management or control requests from management device 111, and the like.

During normal operation of storage system 100, WAN 130 provides the host computer(s) access (i.e. read and/or write) to data stored within storage system 100. In this embodiment, WAN 130 typically enables storage system 100 to provide storage operations to the host computer(s) by enabling storage devices 125 within the storage system 100 to be accessible to the host computer(s) so that storage devices 125 within storage system 100 appear to an operating system(s) of the host computer(s) as local to the host computer(s). In other words, the storage system 100 typically may appear to the operating system of the host computer as being a storage device within the host computer even though storage system 100 is communicatively connected to that host computer by WAN 130. A benefit of such implementation is that the amount of storage resource within storage system 100 may be treated as a pool of resources that can be centrally managed and allocated on an as-needed basis. Further, this type of implementation may be highly scalable because additional storage capacity can be added to storage system 100, as required. However, as is consistent with each embodiment of the present invention, due to storage system 100 initial setup, component error, failure or otherwise, both storage system 100 and management device 120 cannot communicate with any other device through WAN 130.

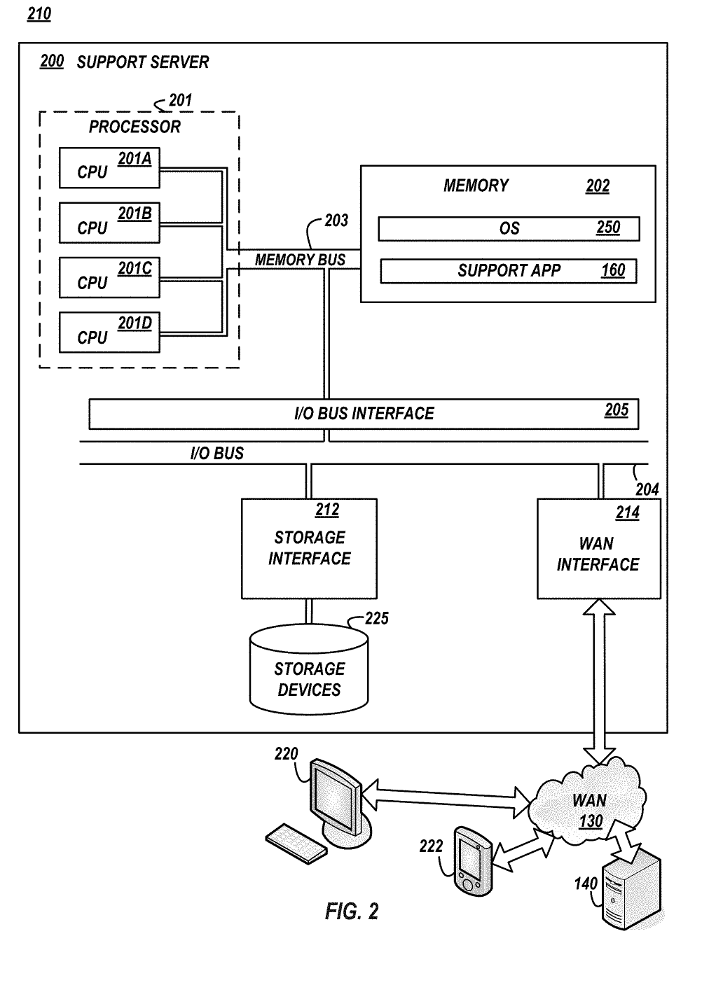

FIG. 2 illustrates a high-level block diagram of an exemplary support server 200, according to various embodiments of the invention. Support server 200 may include one or more processors 201, a main memory 202, storage interface 212, and/or a WAN interface 214, all of which are communicatively coupled, directly or indirectly, for inter-component communication via a memory bus 203, a I/O bus 204, and/or an I/O bus interface 205. The support server 200 contains one or more general-purpose programmable central processing units (CPUs) 201A, 201B, 201C, and 201D, herein generically referred to as the processor 201. In an embodiment, the support server 200 contains multiple processors typical of a relatively large system; however, in another embodiment the support server 200 may alternatively be a single CPU system. Each processor 201 executes instructions stored in the main memory 202 and may comprise one or more levels of on-board cache.

In an embodiment, the main memory 202 may comprise a random-access semiconductor memory or storage medium for storing or encoding data and programs. In another embodiment, the main memory 202 represents the entire virtual memory of the support server 200 and may also include the virtual memory of other computer systems coupled to the support server 200. The main memory 202 is conceptually a single monolithic entity, but in other embodiments the main memory 202 is a more complex arrangement, such as a hierarchy of caches and other memory devices. For example, memory 202 may exist in multiple levels of caches, and these caches may be further divided by function, so that one cache holds instructions while another holds non-instruction data, which is used by the processor or processors. Memory 202 may be further distributed and associated with different CPUs or sets of CPUs, as is known in any of various so-called non-uniform memory access (NUMA) computer architectures.

The main memory 202 stores or encodes an operating system 150 and a portion of a support application 160, or the like. While operating system 250 and support application portion 160 are illustrated as being contained within the main memory 202, these elements are not necessarily all completely contained in the same memory at the same time. Further, although operating system 250 and support application portion 160 are illustrated as being separate entities, in other embodiments some of them, portions of some of them, or all of them may be packaged together. Operating system 250 and support application portion 160 generally comprise program instructions or statements that are called and executed by the processor 201 to cause the support server 200 to implement functionality further described herein.

The memory bus 203 provides a data communication path for transferring data among the processor 201, the main memory 202, and the I/O bus interface 205. The I/O bus interface 205 is further coupled to the system I/O bus 204 for transferring data to and from the various I/O interfaces. The I/O bus interface 205 communicates with multiple I/O interfaces 212 and 214 through the system I/O bus 204. The I/O interfaces support communication with a variety of devices.

The storage interface 212 supports the attachment of one or more storage devices 225. In an embodiment, the storage devices 225 are rotating magnetic disk drive storage devices, solid state storage devices, or similar other types of storage device(s). The contents of the main memory 202, or any portion thereof, may be stored to and retrieved from the storage device(s) 225, as needed. The local storage devices 225 generally have a slower access time than does the memory 202, meaning that the time needed to read and/or write data from/to the memory 202 is less than the time needed to read and/or write data from/to for the local storage device(s) 225.

Although the memory bus 203 is shown as a relatively simple, single bus structure providing a direct communication path among the processors 201, the main memory 202, and the I/O bus interface 205, in fact the memory bus 203 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 205 and the I/O bus 204 are shown as single respective entities, the support server 200 may, in fact, contain multiple I/O bus interfaces 205 and/or multiple I/O buses 204. While multiple I/O interfaces are shown, which separate the system I/O bus 204 from various communications paths running to the various I/O devices, in other embodiments some or all of the I/O devices are connected directly to one or more system I/O buses.

The WAN interface 214 provides one or more communications paths from the support server 200 to other remote devices by way of WAN 130. WAN interface 214 may contain electronic components and logic to adapt or convert data of one protocol on I/O bus 204 to another protocol on another bus. For example, WAN interface 214 may connect support device 220, a mobile device 222, and/or SMTP server 140 to support server 200 by way of WAN 130.

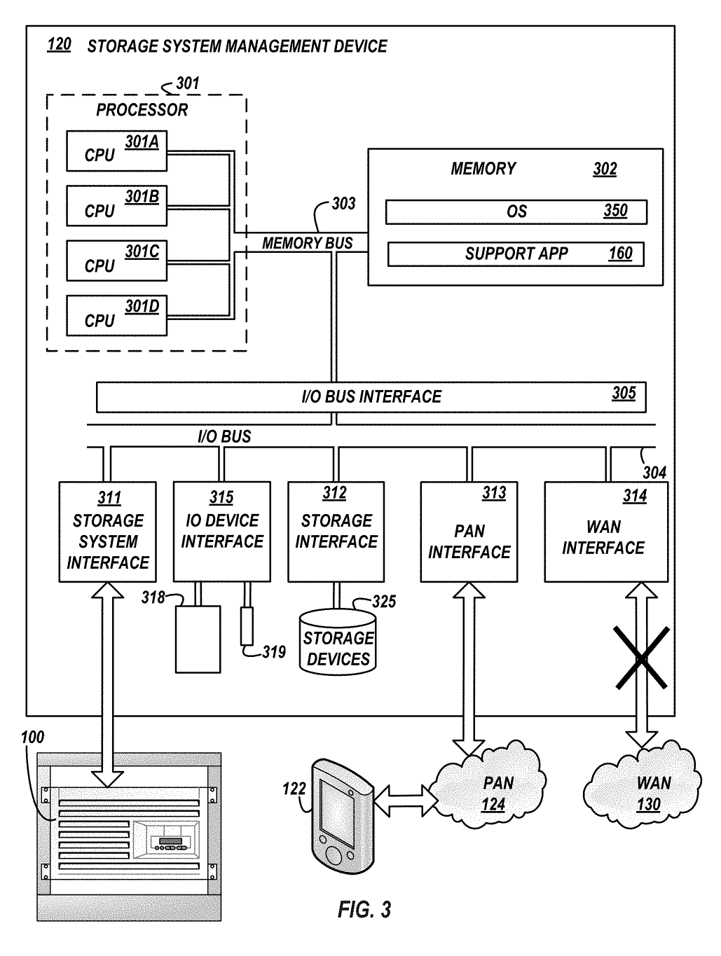

FIG. 3 illustrates a high-level block diagram of storage system management device 120, according to various embodiments of the invention. Management device 120 may include one or more processors 301, a main memory 302, a storage system interface 311, a storage interface 312, a PAN interface 313, a WAN interface 314, and/or an I/O device interface 315 all of which are communicatively coupled, directly or indirectly, for inter-component communication via a memory bus 303, a I/O bus 304, and/or an I/O bus interface 305. The management device 120 contains one or more general-purpose programmable central processing units (CPUs) 301A, 301B, 301C, and 301D, herein generically referred to as the processor 301. In an embodiment, the management device 120 contains multiple processors typical of a relatively large system; however, in another embodiment the management device 120 may alternatively be a single CPU system. Each processor 301 executes instructions stored in the main memory 302 and may comprise one or more levels of on-board cache.

In an embodiment, the main memory 302 may comprise a random-access semiconductor memory or storage medium for storing or encoding data and programs. In another embodiment, the main memory 302 represents the entire virtual memory of the management device 120 and may also include the virtual memory of other computer systems coupled to the management device 120. The main memory 302 is conceptually a single monolithic entity, but in other embodiments the main memory 302 is a more complex arrangement, such as a hierarchy of caches and other memory devices. For example, memory 302 may exist in multiple levels of caches, and these caches may be further divided by function, so that one cache holds instructions while another holds non-instruction data, which is used by the processor or processors. Memory 302 may be further distributed and associated with different CPUs or sets of CPUs, as is known in any of various so-called non-uniform memory access (NUMA) computer architectures.

The main memory 302 stores or encodes an operating system 350 and a portion of a support application 160, or the like. While operating system 350 and support application portion 160 are illustrated as being contained within the main memory 302, these elements are not necessarily all completely contained in the same memory at the same time. Further, although operating system 350 and support application portion 160 are illustrated as being separate entities, in other embodiments some of them, portions of some of them, or all of them may be packaged together. Operating system 350 support application portion 160 generally comprise program instructions or statements that are called and executed by the processor 301 to cause the management device 120 to implement functionality further described herein.

The memory bus 303 provides a data communication path for transferring data among the processor 301, the main memory 302, and the I/O bus interface 305. The I/O bus interface 305 is further coupled to the system I/O bus 304 for transferring data to and from the various I/O interfaces. The I/O bus interface 305 communicates with multiple I/O interfaces 311, 312, 313, 314, 315 through the system I/O bus 304. The I/O interfaces support communication with a variety of devices. For example, the storage system interface 311 supports the attachment of storage system 100.

The storage interface 312 supports the attachment of one or more storage devices 325. In an embodiment, the storage devices 325 are rotating magnetic disk drive storage devices, solid state storage devices, or similar other types of storage device(s). The contents of the main memory 302, or any portion thereof, may be stored to and retrieved from the storage device(s) 325, as needed. The local storage devices 325 generally have a slower access time than does the memory 302, meaning that the time needed to read and/or write data from/to the memory 302 is less than the time needed to read and/or write data from/to for the local storage device(s) 325.

I/O device interface 315 supports communication with various I/O devices, such as screen 318, keyboard 319, or the like. Such I/O devices may be user output devices (such as a video display device, speaker, and/or television set) and user input devices (such as a keyboard, mouse, microphone, keypad, touchpad, trackball, buttons, light pen, or other pointing device). A user may manipulate the user input devices using a user interface to provide input data and commands to management device 120 and may receive output data via the user output devices. For example, a user interface may be presented by management device 120, such as displayed on screen 318, played via a speaker, or printed via a printer.

The PAN interface 313 provides a communication path from the management device 120 to mobile device 122, by way of PAN 124. The WAN interface 314 provides one or more communications paths from the management device 120 to other remote devices by way of WAN 130.

Although the memory bus 303 is shown as a relatively simple, single bus structure providing a direct communication path among the processors 301, the main memory 302, and the I/O bus interface 305, in fact the memory bus 303 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 305 and the I/O bus 304 are shown as single respective entities, the management device 120 may, in fact, contain multiple I/O bus interfaces 305 and/or multiple I/O buses 304. While multiple I/O interfaces are shown, which separate the system I/O bus 304 from various communications paths running to the various I/O devices, in other embodiments some or all the I/O devices are connected directly to one or more system I/O buses.

Though shown as distinct entities, the multiple I/O interfaces 311, 312, 313, 314, and 315 or the functionality of the I/O interfaces 311, 312, 313, 314, and 315 may be integrated into the same entity.

As indicated herein and as is consistent with each embodiment of the present invention, due to management device 120 initial setup, component error, failure or otherwise, both management device 120 and management device 120 cannot communicate with any other device through WAN 130.

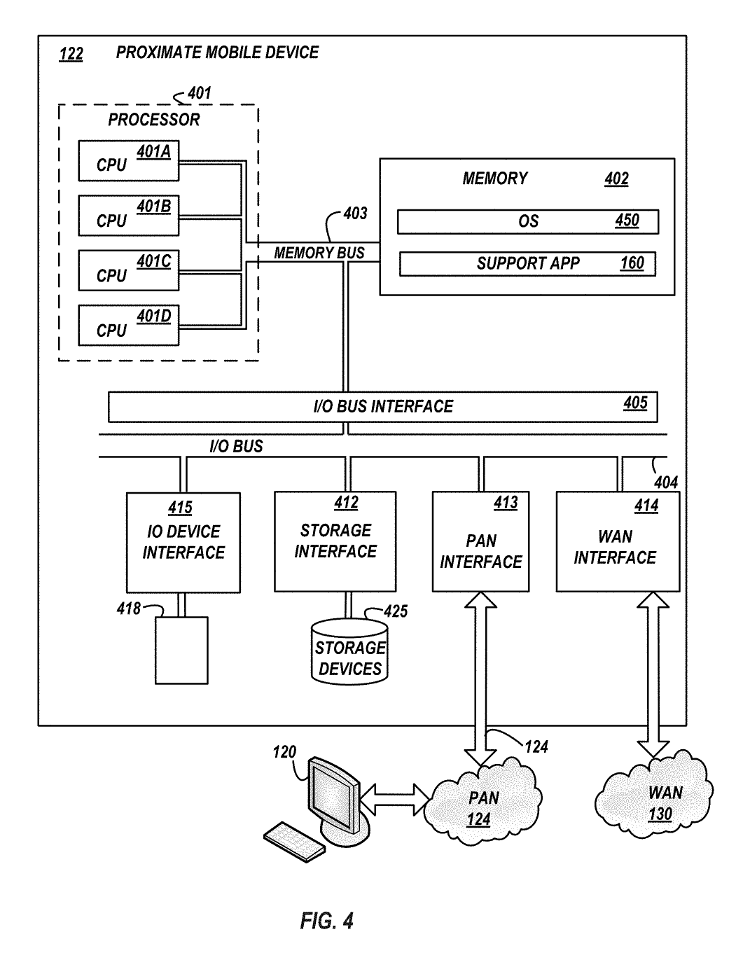

FIG. 4 illustrates a high-level block diagram of a proximate mobile device 122, according to various embodiments of the invention. Mobile device 122 may include one or more processors 401, a main memory 402, a storage interface 412, a PAN interface 413, a WAN interface 414, and/or an I/O device interface 415 all of which are communicatively coupled, directly or indirectly, for inter-component communication via a memory bus 403, a I/O bus 404, and/or an I/O bus interface 405. The Mobile device 122 contains one or more general-purpose programmable central processing units (CPUs) 401A, 401B, 401C, and 401D, herein generically referred to as the processor 401. In an embodiment, the Mobile device 122 contains multiple processors typical of a relatively large system; however, in another embodiment the Mobile device 122 may alternatively be a single CPU system. Each processor 401 executes instructions stored in the main memory 402 and may comprise one or more levels of on-board cache.

In an embodiment, the main memory 402 may comprise a random-access semiconductor memory or storage medium for storing or encoding data and programs. In another embodiment, the main memory 402 represents the entire virtual memory of the mobile device 122 and may also include the virtual memory of other computer systems coupled to the mobile device 122. The main memory 402 is conceptually a single monolithic entity, but in other embodiments the main memory 402 is a more complex arrangement, such as a hierarchy of caches and other memory devices. For example, memory 402 may exist in multiple levels of caches, and these caches may be further divided by function, so that one cache holds instructions while another holds non-instruction data, which is used by the processor or processors. Memory 402 may be further distributed and associated with different CPUs or sets of CPUs, as is known in any of various so-called non-uniform memory access (NUMA) computer architectures.

The main memory 402 stores or encodes an operating system 350 and a portion of a support application 160, or the like. While operating system 450 and support application portion 160 are illustrated as being contained within the main memory 402, these elements are not necessarily all completely contained in the same memory at the same time. Further, although operating system 450 and support application portion 160 are illustrated as being separate entities, in other embodiments some of them, portions of some of them, or all of them may be packaged together. Operating system 450 support application portion 160 generally comprise program instructions or statements that are called and executed by the processor 401 to cause the mobile device 122 to implement functionality further described herein.

The memory bus 403 provides a data communication path for transferring data among the processor 401, the main memory 402, and the I/O bus interface 405. The I/O bus interface 405 is further coupled to the system I/O bus 404 for transferring data to and from the various I/O interfaces. The I/O bus interface 405 communicates with multiple I/O interfaces 412, 413, 414, 415 through the system I/O bus 404. The I/O interfaces support communication with a variety of devices.

The storage interface 412 supports the attachment of one or more storage devices 425. In an embodiment, the storage devices 425 are rotating magnetic disk drive storage devices, solid state storage devices, or similar other types of storage device(s). The contents of the main memory 402, or any portion thereof, may be stored to and retrieved from the storage device(s) 425, as needed. The local storage devices 425 generally have a slower access time than does the memory 402, meaning that the time needed to read and/or write data from/to the memory 402 is less than the time needed to read and/or write data from/to for the local storage device(s) 425.

I/O device interface 415 supports communication with various I/O devices, such as touch screen 418 or the like. Such I/O devices may be user output devices (such as a video display device, speaker, or the like) and user input devices (such as a keyboard, mouse, microphone, keypad, touchpad, trackball, buttons, light pen, or other pointing device). A user may manipulate the user input devices using a user interface to provide input data and commands to mobile device 122 and may receive output data via the user output devices. For example, a user interface may be presented by mobile device 122, such as displayed on touch screen 418, played via a speaker, or printed via a printer.

The PAN interface 413 provides a communication path from the mobile device 122 to mobile device 122, by way of PAN 124. The WAN interface 414 provides one or more communications paths from the mobile device 122 to other remote devices by way of WAN 130.

Although the memory bus 403 is shown as a relatively simple, single bus structure providing a direct communication path among the processors 401, the main memory 402, and the I/O bus interface 405, in fact the memory bus 403 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 405 and the I/O bus 404 are shown as single respective entities, the mobile device 122 may, in fact, contain multiple I/O bus interfaces 405 and/or multiple I/O buses 404. While multiple I/O interfaces are shown, which separate the system I/O bus 404 from various communications paths running to the various I/O devices, in other embodiments some or all the I/O devices are connected directly to one or more system I/O buses.

Though shown as distinct entities, the multiple I/O interfaces 412, 413, 414, and 415 or the functionality of the I/O interfaces 412, 413, 414, and 415 may be integrated into the same entity.

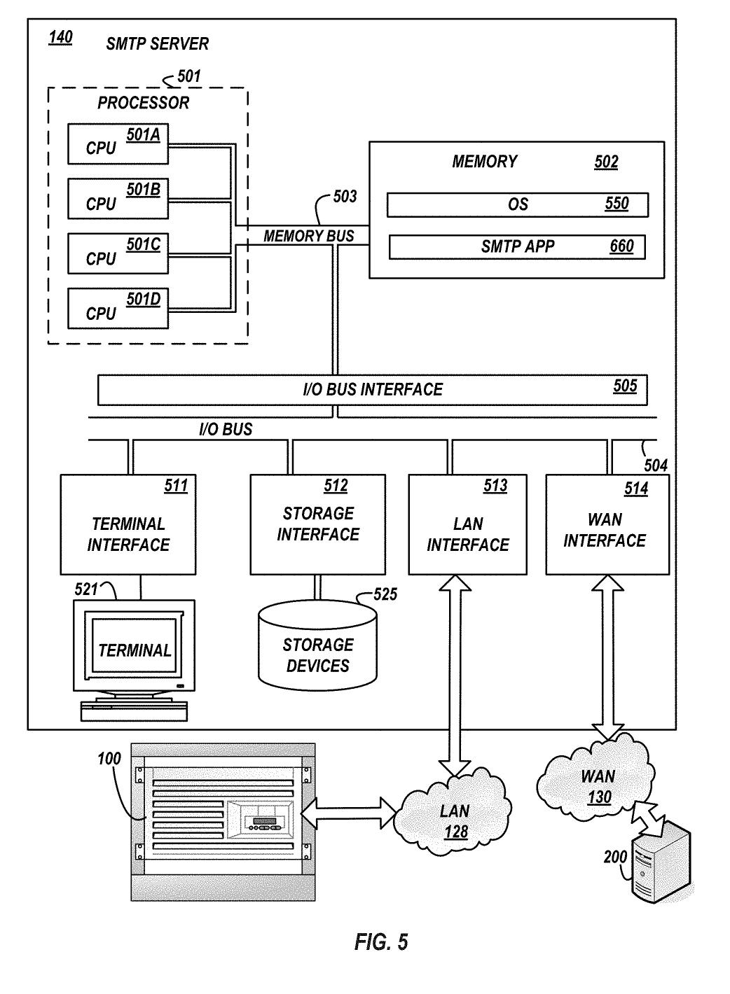

FIG. 5 illustrates a high-level block diagram of a Simple Mail Transfer Protocol (SMTP) server 140, according to various embodiments of the invention. Server 140 may include one or more processors 501, a main memory 502, a terminal interface 511, a storage interface 512, LAN interface 513, and/or a WAN interface 514, all of which are communicatively coupled, directly or indirectly, for inter-component communication via a memory bus 503, a I/O bus 504, and/or an I/O bus interface 505. The server 140 contains one or more general-purpose programmable central processing units (CPUs) 501A, 501B, 501C, and 501D, herein generically referred to as the processor 501. In an embodiment, the server 140 contains multiple processors typical of a relatively large system; however, in another embodiment the server 140 may alternatively be a single CPU system. Each processor 501 executes instructions stored in the main memory 502 and may comprise one or more levels of on-board cache.

In an embodiment, the main memory 502 may comprise a random-access semiconductor memory or storage medium for storing or encoding data and programs. In another embodiment, the main memory 502 represents the entire virtual memory of the server 140 and may also include the virtual memory of other computer systems coupled to the server 140. The main memory 502 is conceptually a single monolithic entity, but in other embodiments the main memory 502 is a more complex arrangement, such as a hierarchy of caches and other memory devices. For example, memory 502 may exist in multiple levels of caches, and these caches may be further divided by function, so that one cache holds instructions while another holds non-instruction data, which is used by the processor or processors. Memory 502 may be further distributed and associated with different CPUs or sets of CPUs, as is known in any of various so-called non-uniform memory access (NUMA) computer architectures.

The main memory 502 stores or encodes an operating system 150 and a SMTP application 660, or the like. While operating system 150 and SMTP application 660 are illustrated as being contained within the main memory 502, these elements are not necessarily all completely contained in the same memory at the same time. Further, although operating system 150 and SMTP application 660 are illustrated as being separate entities, in other embodiments some of them, portions of some of them, or all of them may be packaged together. Operating system 150 and SMTP application 660 generally comprise program instructions or statements that are called and executed by the processor 501 to cause the server 140 to implement functionality further described herein.

The memory bus 503 provides a data communication path for transferring data among the processor 501, the main memory 502, and the I/O bus interface 505. The I/O bus interface 505 is further coupled to the system I/O bus 504 for transferring data to and from the various I/O interfaces. The I/O bus interface 505 communicates with multiple I/O interfaces 511, 512, 513, and 514 through the system I/O bus 504. The I/O interfaces support communication with a variety of devices. For example, the terminal interface 511 supports the attachment of a terminal 521 which may comprise user output devices (such as a video display device, speaker, and/or television set) and user input devices (such as a keyboard, mouse, microphone, keypad, touchpad, trackball, buttons, light pen, or other pointing device). A user may manipulate the user input devices using a user interface to provide input data and commands to terminal 521 and may receive output data via the user output devices. For example, a user interface may be presented by terminal 521, such as displayed on a display device, played via a speaker, or printed via a printer. Terminal 511 may be communicatively connected to server 140 by a bus connection.

The storage interface 512 supports the attachment of one or more storage devices 525. In an embodiment, the storage devices 525 are rotating magnetic disk drive storage devices, solid state storage devices, or similar other types of storage device(s). The contents of the main memory 502, or any portion thereof, may be stored to and retrieved from the storage device(s) 525, as needed. The local storage devices 525 generally have a slower access time than does the memory 502, meaning that the time needed to read and/or write data from/to the memory 502 is less than the time needed to read and/or write data from/to for the local storage device(s) 525.

The LAN interface 513 provides one or more communications paths from the server 140 to other local devices, such as storage system 100, by way of LAN 128. The WAN interface 514 provides one or more communications paths from the server 140 to other remote devices, such as support server 200, by way of WAN 130.

Although the memory bus 503 is shown as a relatively simple, single bus structure providing a direct communication path among the processors 501, the main memory 502, and the I/O bus interface 505, in fact the memory bus 503 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 505 and the I/O bus 504 are shown as single respective entities, the server 140 may, in fact, contain multiple I/O bus interfaces 505 and/or multiple I/O buses 504. While multiple I/O interfaces are shown, which separate the system I/O bus 504 from various communications paths running to the various I/O devices, in other embodiments some or all of the I/O devices are connected directly to one or more system I/O buses.

Though shown as distinct entities, the multiple I/O interfaces 511, 512, 513, and 514 or the functionality of the I/O interfaces 511, 512, 513, and 514 may be integrated into the same entity. In various embodiments, the server 140 is a multi-user SMTP server, a single-user SMTP server, or a similar device that has little or no direct user interface.

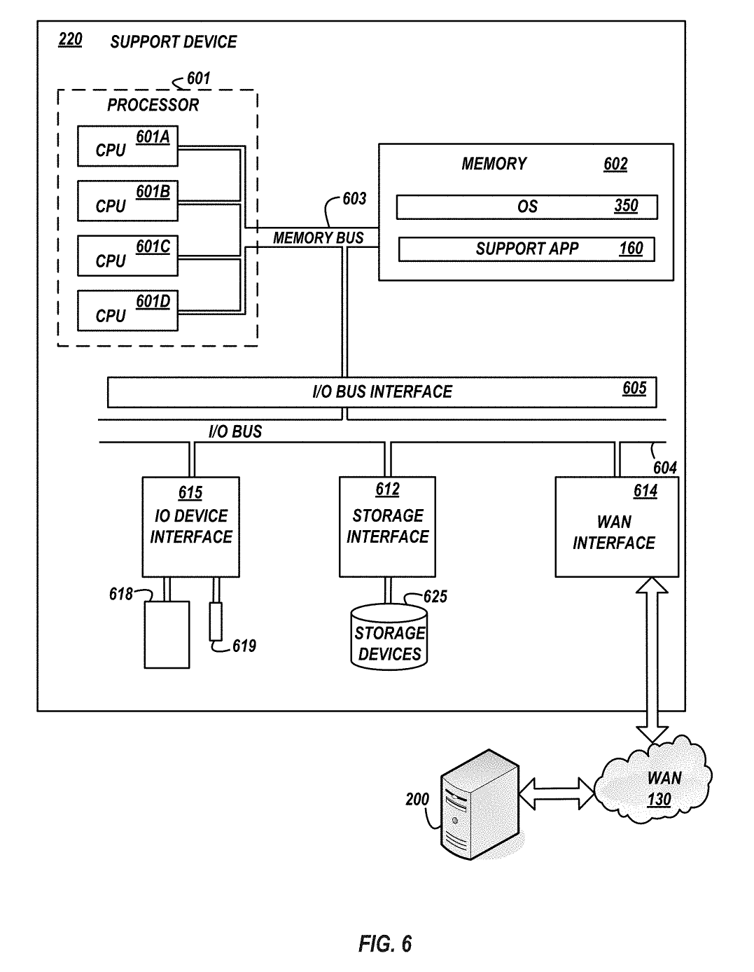

FIG. 6 illustrates a high-level block diagram of support device 220, according to various embodiments of the invention. Support device 220 may include one or more processors 601, a main memory 602, a storage interface 612, a WAN interface 614, and/or an I/O device interface 615 all of which are communicatively coupled, directly or indirectly, for inter-component communication via a memory bus 603, a I/O bus 604, and/or an I/O bus interface 605. The support device 220 contains one or more general-purpose programmable central processing units (CPUs) 601A, 601B, 601C, and 601D, herein generically referred to as the processor 601. In an embodiment, the support device 220 contains multiple processors typical of a relatively large system; however, in another embodiment the support device 220 may alternatively be a single CPU system. Each processor 601 executes instructions stored in the main memory 602 and may comprise one or more levels of on-board cache.

In an embodiment, the main memory 602 may comprise a random-access semiconductor memory or storage medium for storing or encoding data and programs. In another embodiment, the main memory 602 represents the entire virtual memory of the support device 220 and may also include the virtual memory of other computer systems coupled to the support device 220. The main memory 602 is conceptually a single monolithic entity, but in other embodiments the main memory 602 is a more complex arrangement, such as a hierarchy of caches and other memory devices. For example, memory 602 may exist in multiple levels of caches, and these caches may be further divided by function, so that one cache holds instructions while another holds non-instruction data, which is used by the processor or processors. Memory 602 may be further distributed and associated with different CPUs or sets of CPUs, as is known in any of various so-called non-uniform memory access (NUMA) computer architectures.

The main memory 602 stores or encodes an operating system 650 and a portion of a support application 160, or the like. While operating system 650 and support application portion 160 are illustrated as being contained within the main memory 602, these elements are not necessarily all completely contained in the same memory at the same time. Further, although operating system 650 and support application portion 160 are illustrated as being separate entities, in other embodiments some of them, portions of some of them, or all of them may be packaged together. Operating system 650 support application portion 160 generally comprise program instructions or statements that are called and executed by the processor 601 to cause the support device 220 to implement functionality further described herein.

The memory bus 603 provides a data communication path for transferring data among the processor 601, the main memory 602, and the I/O bus interface 605. The I/O bus interface 605 is further coupled to the system I/O bus 604 for transferring data to and from the various I/O interfaces. The I/O bus interface 605 communicates with multiple I/O interfaces 612, 614, and 615 through the system I/O bus 604. The I/O interfaces support communication with a variety of devices.

The storage interface 612 supports the attachment of one or more storage devices 625. In an embodiment, the storage devices 625 are rotating magnetic disk drive storage devices, solid state storage devices, or similar other types of storage device(s). The contents of the main memory 602, or any portion thereof, may be stored to and retrieved from the storage device(s) 625, as needed. The local storage devices 625 generally have a slower access time than does the memory 602, meaning that the time needed to read and/or write data from/to the memory 602 is less than the time needed to read and/or write data from/to for the local storage device(s) 625.

The WAN interface 614 provides one or more communications paths from the support device 220 to other remote devices, such as support server 200, by way of WAN 130. I/O device interface 615 supports communication with various I/O devices, such as screen 618, keyboard 619, or the like. Such I/O devices may be user output devices (such as a video display device, speaker, and/or television set) and user input devices (such as a keyboard, mouse, microphone, keypad, touchpad, trackball, buttons, light pen, or other pointing device). A user may manipulate the user input devices using a user interface to provide input data and commands to support device 220 and may receive output data via the user output devices. For example, a user interface may be presented by support device 220, such as displayed on screen 618, played via a speaker, or printed via a printer.

Although the memory bus 603 is shown as a relatively simple, single bus structure providing a direct communication path among the processors 601, the main memory 602, and the I/O bus interface 605, in fact the memory bus 603 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 605 and the I/O bus 604 are shown as single respective entities, the support device 220 may, in fact, contain multiple I/O bus interfaces 605 and/or multiple I/O buses 604. While multiple I/O interfaces are shown, which separate the system I/O bus 604 from various communications paths running to the various I/O devices, in other embodiments some or all the I/O devices are connected directly to one or more system I/O buses.

Though shown as distinct entities, the multiple I/O interfaces 612, 614, and 615 or the functionality of the I/O interfaces 612, 614, and 615 may be integrated into the same entity.

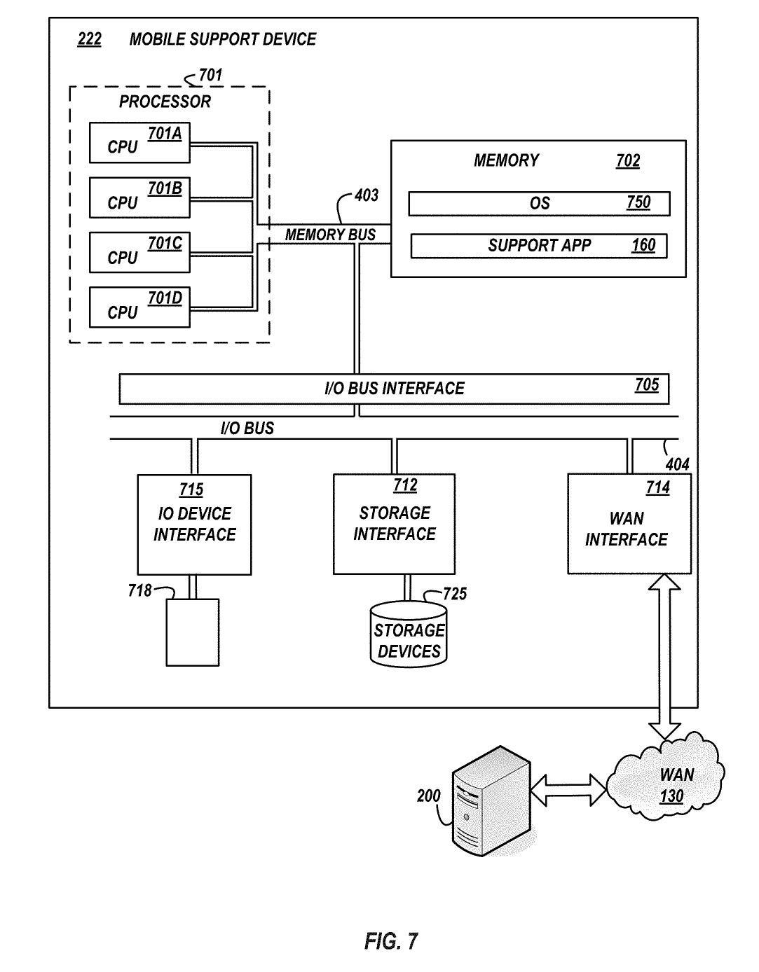

FIG. 7 illustrates a high-level block diagram of mobile support device 222, according to various embodiments of the invention. Mobile support device 222 may include one or more processors 701, a main memory 702, a storage interface 712, a WAN interface 714, and/or an I/O device interface 715 all of which are communicatively coupled, directly or indirectly, for inter-component communication via a memory bus 703, a I/O bus 704, and/or an I/O bus interface 705. The Mobile support device 222 contains one or more general-purpose programmable central processing units (CPUs) 701A, 701B, 701C, and 701D, herein generically referred to as the processor 701. In an embodiment, the Mobile support device 222 contains multiple processors typical of a relatively large system; however, in another embodiment the Mobile support device 222 may alternatively be a single CPU system. Each processor 701 executes instructions stored in the main memory 702 and may comprise one or more levels of on-board cache.

In an embodiment, the main memory 702 may comprise a random-access semiconductor memory or storage medium for storing or encoding data and programs. In another embodiment, the main memory 702 represents the entire virtual memory of the mobile support device 222 and may also include the virtual memory of other computer systems coupled to the mobile support device 222. The main memory 702 is conceptually a single monolithic entity, but in other embodiments the main memory 702 is a more complex arrangement, such as a hierarchy of caches and other memory devices. For example, memory 702 may exist in multiple levels of caches, and these caches may be further divided by function, so that one cache holds instructions while another holds non-instruction data, which is used by the processor or processors. Memory 702 may be further distributed and associated with different CPUs or sets of CPUs, as is known in any of various so-called non-uniform memory access (NUMA) computer architectures.

The main memory 702 stores or encodes an operating system 350 and a portion of a support application 160, or the like. While operating system 750 and support application portion 160 are illustrated as being contained within the main memory 702, these elements are not necessarily all completely contained in the same memory at the same time. Further, although operating system 750 and support application portion 160 are illustrated as being separate entities, in other embodiments some of them, portions of some of them, or all of them may be packaged together. Operating system 750 support application portion 160 generally comprise program instructions or statements that are called and executed by the processor 701 to cause the mobile support device 222 to implement functionality further described herein.

The memory bus 703 provides a data communication path for transferring data among the processor 701, the main memory 702, and the I/O bus interface 705. The I/O bus interface 705 is further coupled to the system I/O bus 704 for transferring data to and from the various I/O interfaces. The I/O bus interface 705 communicates with multiple I/O interfaces 712, 714, 715 through the system I/O bus 704. The I/O interfaces support communication with a variety of devices.

The storage interface 712 supports the attachment of one or more storage devices 725. In an embodiment, the storage devices 725 are rotating magnetic disk drive storage devices, solid state storage devices, or similar other types of storage device(s). The contents of the main memory 702, or any portion thereof, may be stored to and retrieved from the storage device(s) 725, as needed. The local storage devices 725 generally have a slower access time than does the memory 702, meaning that the time needed to read and/or write data from/to the memory 702 is less than the time needed to read and/or write data from/to for the local storage device(s) 725.

The WAN interface 714 provides one or more communications paths from the mobile support device 222 to other remote devices by way of WAN 130. I/O device interface 715 supports communication with various I/O devices, such as touch screen 718 or the like. Such I/O devices may be user output devices (such as a video display device, speaker, or the like) and user input devices (such as a keyboard, mouse, microphone, keypad, touchpad, trackball, buttons, light pen, or other pointing device). A user may manipulate the user input devices using a user interface to provide input data and commands to mobile support device 222 and may receive output data via the user output devices. For example, a user interface may be presented by mobile support device 222, such as displayed on touch screen 718, played via a speaker, or printed via a printer.

Although the memory bus 703 is shown as a relatively simple, single bus structure providing a direct communication path among the processors 701, the main memory 702, and the I/O bus interface 705, in fact the memory bus 703 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 705 and the I/O bus 704 are shown as single respective entities, the mobile support device 222 may, in fact, contain multiple I/O bus interfaces 705 and/or multiple I/O buses 704. While multiple I/O interfaces are shown, which separate the system I/O bus 704 from various communications paths running to the various I/O devices, in other embodiments some or all the I/O devices are connected directly to one or more system I/O buses.

Though shown as distinct entities, the multiple I/O interfaces 712, 714, and 715 or the functionality of the I/O interfaces 712, 714, and 715 may be integrated into the same entity.

As is consistent with FIG. 1-FIG. 7, SMTP server 140, proximate mobile device 122, support server 200, support device 220, and/or mobile support device 222 are communicatively connected by way of WAN 130. Storage system 100 and management device 120 (if utilized) are not communicatively connected to any device by way of WAN 130 due to storage system 100 and/or management device 120 setup, component error, failure, or otherwise. As such, because storage system 100 is not communicatively connected to any device by way of WAN 130 but another device within the same LAN 128 as storage system 100, e.g., SMTP server 140, is connected to WAN 130, storage system 100 is indirectly connected to WAN 130 by way of e.g., SMTP server 140.

FIG. 1-FIG. 7 are intended to depict representative major components of respective computers, data handling devices, or the like. Individual components may have greater complexity than represented therein, components other than or in addition to those depicted may be present, and the number, type, and configuration of such components may vary.

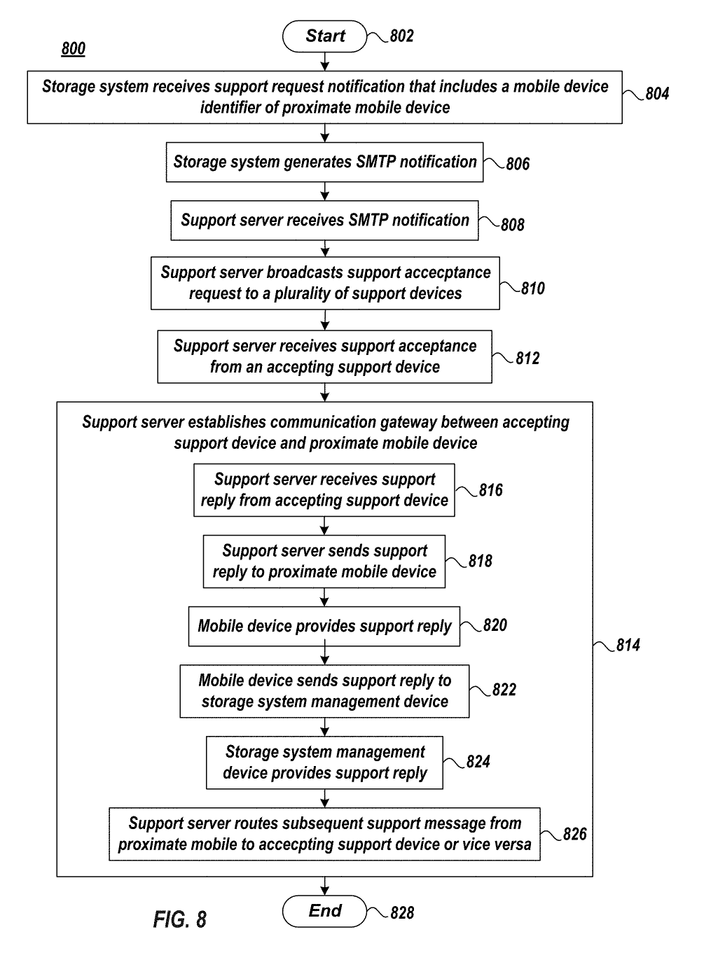

FIG. 8 illustrates method 800 of implementing a support chat session for and from storage system 100 that is indirectly connected to WAN 130, according to various embodiments of the invention. Method 800 may be utilized by support application 160 that when evoked by the associated processor, causes the indicated device to perform the denoted functionality.

Method 800 begins at block 802 and continues with storage system 100 receiving a support request notification (block 804). The support request notification includes at least a request for a support session and an identifier (e.g., IP address, global unique identification number (GUID), a unique installation instance identifier of the portion of application 160 within memory 402, or the like) that uniquely identifies the proximate mobile device 122, amongst several possible mobile devices, that is proximately located to storage system 100. The support request notification may be generated upon management device 120 or proximate mobile device 122. For example, a GUI is presented upon e.g., screen 318, touch screen 418, and an associated user may select an “request support” GUI object. The support request notification may also include support text or a message received by an input device of management device 120 or by an input device of proximate mobile device 122. If the support request notification is generated by management device 120, the support request notification is directly communicated from device 120 to storage system 100 by the bus connection that connects management device 120 and storage system 100. If the support request notification is generated by mobile device 122, the support request notification is communicated from device 122 to management device 122 by PAN 124 and then communicated from device 120 to storage system 100 by the bus connection that connects management device 120 and storage system 100.

Method 800 may continue with storage system 100 generating an SMTP notification (block 806). The SMTP notification, such as an email, includes the information that which is included within the support request notification and includes at least an identifier (e.g., SMTP server 140 IP address, a sender email address, or the like) of the storage system 100 and an SMTP identifier (e.g., a receiver email address, or the like) of the support server 200. The SMTP notification may also include data about storage system 100, such as storage system 100 configuration data, storage system 100 operational dashboard data, error code, data associated with the owner or user(s) of storage system 100, or the like.

Method 800 may continue with support server 200 receiving the SMTP notification (block 808) by the storage system 100 sending the SMTP notification to support server 200 by way of SMTP server 140. As such, the storage system initiates the support session by sending the SMTP notification to SMTP server 140 by way of LAN 128, where in turn, SMTP server 140 sends the SMTP notification to support server 200 by way of WAN 130.

Method 800 may continue with support server 200 broadcasting a support acceptance request to numerous support devices (block 810). The support acceptance request may include information that which was included in the SMTP notification. For example, the support acceptance request may include information about the owner or user(s) of storage system 100, the error code of one or more components of storage system 100, or the like. Method 800 may continue with support server 200 receiving an acceptance from one of the numerous support devices (block 812). For example, a GUI is presented upon e.g., screen 618, touch screen 718, and an associated user may select an “accept chat” GUI object which causes the support device 220 or mobile support device 222 to send the acceptance message of the support acceptance request to support server 200.

Method 800 may continue with support server 200 establishing a communication gateway between the accepting support device and the proximate mobile device 122 (block 814). For example, the communication gateway is established by way of WAN 130 between the accepting support device and the proximate mobile device 122 associated with the identifier that uniquely identifies the proximate mobile device 122, amongst several possible mobile devices, that is proximately located to storage system 100 through support server 130.

For example, a first chat window is displayed within the GUI upon e.g., screen 618, touch screen 718, etc. and a second chat window is displayed within the GUI upon screen 122. The first chat window is communicatively connected to the second chat window by the communication gateway through server 200 by way of WAN 130. Text messages may be received by input devices of device 220 or input devices of device 222 and may displayed in the first chat window. For example, a support reply text message may be received by input devices of device 220 or by input devices of device 222, may be displayed within the first window, and sent to support server 200. The server 200 receives the support reply text message (block 816) and sends the support reply text message to the applicable proximate mobile device 122 (block 818). The proximate mobile device 122 may provide the support reply text message via the second chat window upon screen 418 of the proximate mobile device 122 (block 820).

In another example, a first conversation interface is provided by a first voice user interface by the accepting supporting device and a second conversation interface is provided by a second voice user interface by the proximate mobile device 122. The first conversation interface is communicatively connected to the second conversation interface by the communication gateway through server 200 by way of WAN 130. Audio messages may be received by the first communication interface by way of input devices (e.g., microphone, or the like) of device 220 or input devices of device 222 (e.g., microphone, or the like) and sent to support server 200. The server 200 receives the support reply audio message (block 816) and sends the support reply audio message to the second communication interface upon the applicable proximate mobile device 122 (block 818). The second communication interface of the proximate mobile device 122 may provide the support reply audio message by an output device (e.g., speaker, or the like) of that device 122 (block 820).

In addition to or in the alternative to the proximate mobile device 122 providing the support reply message, the proximate device 122 may send the support reply message to management device 120 by way of PAN 124 (block 822). For example, proximate mobile device 122 may send the support reply text message to management device 120 by way of PAN 124 or may send the support reply audio message to management device 120 by way of PAN 124.

The communication gateway between the accepting support device and the proximate mobile device 122 may be subsequently utilized to transfer messages such as text messages, audio messages, or the like from the proximate mobile device 122 to the accepting support device, or vice versa (block 826). For example, a subsequent text or audio message may be generated by one or more respective input devices of management device 120. The subsequent message may be sent to the proximate mobile device 122 by way of PAN 124, where in turn, the message may be transmitted by the communication gateway between the mobile device 122 and the accepting support device. Method 800 may end at block 828.

The present invention may be a system, a method, and/or a computer program product. The computer program product may include a computer readable storage medium (or media) having computer readable program instructions thereon for causing one or more processors to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method for implementing a support session for and from a storage system, the method comprising:
receiving, with the storage system, a support session request notification, the support session request notification comprising a mobile device identifier that uniquely identifies an associated proximate mobile device that is communicatively connected to a storage system management device by a personal area network (PAN);
generating, with the storage system, an Simple Mail Transfer Protocol (SMTP) notification comprising the mobile device identifier;
receiving, with a support session management server, the SMTP notification;
receiving, with the support session management server, a support session acceptance notification from an accepting support device;
establishing, with the support session management server, a communication gateway between the accepting support device and the proximate mobile device associated with the mobile device identifier;
routing, with the support session management server, a support message from the accepting support device to the proximate mobile device associated with the mobile device identifier.

2. The method of claim 1, wherein receiving the SMTP notification comprises:
sending the SMTP notification to an SMTP server that is communicatively connected to the storage system by a Local Area Network and that is communicatively connected to the support session management server by a Wide Area Network (WAN); and
sending, with the SMTP server, the SMTP notification to the support session management server.

3. The method of claim 1, further comprising:
providing the support message upon a user interface of the proximate mobile device.

4. The method of claim 1, further comprising:
sending, with the proximate mobile device, the support message to the storage system management device over the PAN.

5. The method of claim 4, further comprising;
providing the support message upon a user interface of the storage system management device.

6. The method of claim 2, wherein the storage system and the storage system management device are not connected to the WAN.

7. The method of claim 1, wherein the storage system management device is communicatively connected to the storage system by a bus.

8. A computer program product for implementing a support session for and from a storage system, the computer program product comprising computer readable storage mediums having program instructions embodied therewith, the program instructions are readable to cause:
a processor of the storage system to receive a support session request notification, the support session request notification comprising a mobile device identifier that uniquely identifies an associated proximate mobile device that is communicatively connected to a storage system management device by a personal area network (PAN);
the processor of the storage system to generate an Simple Mail Transfer Protocol (SMTP) notification comprising the mobile device identifier;
a processor of a support session management server to receive the SMTP notification;
the processor of the support session management server to receive a support session acceptance notification from an accepting support device;
the processor of the support session management server to establish a communication gateway between the accepting support device and the proximate mobile device associated with the mobile device identifier;
the processor of the support session management server to route a support message from the accepting support device to the proximate mobile device associated with the mobile device identifier.

9. The computer program product of claim 8, wherein the program instructions that cause the processor of the support session management server to receive the SMTP notification, cause:
a processor of an SMTP server that is communicatively connected to the storage system by a Local Area Network and that is communicatively connected to the support session management server by a Wide Area Network (WAN) to send the SMTP notification to an SMTP server; and
the processor of an SMTP server to send the SMTP notification to the support session management server.

10. The computer program product of claim 8, wherein the program instructions are further readable to cause:
a processor of the proximate mobile device to provide the support message upon a user interface of the proximate mobile device.

11. The computer program product of claim 8, wherein the program instructions are further readable to cause:
a processor of the proximate mobile device to send the support message to the storage system management device over the PAN.

12. The computer program product of claim 11, wherein the program instructions are further readable to cause:
a processor of the storage system management device to provide the support message upon a user interface of the storage system management device.

13. The computer program product of claim 9, wherein the storage system and the storage system management device are not connected to the WAN.

14. The computer program product of claim 8, wherein the storage system management device is communicatively connected to the storage system by a bus.

15. A computer program product for implementing a support session for and from a storage system, the computer program product comprising computer readable storage mediums having program instructions embodied therewith, the program instructions are readable to cause:
a support session management server to receive an SMTP notification from an SMTP server that is configured to be communicatively connected to a storage system by a local area network (LAN), the SMTP notification comprising a mobile device identifier uniquely identifying a proximate mobile device that is configured to be communicatively connected to a storage system management device by a personal area network (PAN);
the support session management server to broadcast a support session request notification to a plurality of support devices;
the support session management server to receive a support session acceptance notification from an accepting support device;
the support session management server to establish a communication gateway between the accepting support device and the proximate mobile device associated with the mobile device identifier; and
the support session management server to route a support message from the accepting support device to the proximate mobile device that is associated with the mobile device identifier.

16. The computer program product of claim 15, wherein the SMTP server is configured to be communicatively connected to the support session management server by a Wide Area Network (WAN).

17. The computer program product of claim 16, wherein the storage system and the storage system management device are configured to be connected but are not connected to the WAN.

18. The computer program product of claim 15, wherein the storage system management device is configured to be communicatively connected to the storage system by a bus.

19. The computer program product of claim 15, wherein the PAN is a Bluetooth connection.

20. The computer program product of claim 15, wherein the support message is subsequently provided upon a user interface of the proximate mobile device.
